(19) United States
(12) Patent Application Publication
(10) Pub. No.: US 2026/0221422 A1
(43) Pub. Date: Jul. 30, 2026

(54) ELECTRODE ACTIVE MATERIAL COMPOSITE PARTICLES, ELECTRODE COMPOSITE MATERIAL, AND BATTERY

(71) Applicant: TOYOTA JIDOSHA KABUSHIKI KAISHA, Toyota-shi (JP)

(72) Inventors: Masafumi NOSE, Mishima-shi (JP); Ryoshi OHTA, Susono-shi (JP); Takayuki UCHIYAMA, Susono-shi (JP)

(73) Assignee: TOYOTA JIDOSHA KABUSHIKI KAISHA, Toyota-shi (JP)

(21) Appl. No.: 19/438,980

(22) Filed: Jan. 2, 2026

(30) Foreign Application Priority Data
Jan. 29, 2025 (JP) 2025-013057

(51) Int. Cl. H01M 4/36; H01M 4/02; H01M 4/38; H01M 4/583

(52) U.S. Cl. CPC H01M 4/364; H01M 4/386; H01M 4/583; H01M 2004/021

(57) ABSTRACT

Electrode active material composite particles according to the present disclosure include a porous carbon material and silicon retained within the porous carbon material. The electrode active material composite particles according to the present disclosure have pores of 10 nm or smaller, as measured by the gas adsorption method, in an amount of 0.22 cc/g or more. The electrode composite material according to the present disclosure contains the electrode active material composite particles according to the present disclosure. The battery according to the present disclosure has an electrode active material layer, and also the electrode active material layer contains the electrode composite material according to the present disclosure.

### CROSS-REFERENCE TO RELATED APPLICATION

This application claims priority to Japanese Patent Application No. 2025-013057 filed on Jan. 29, 2025. The disclosure of the above-identified application, including the specification, drawings, and claims, is incorporated by reference herein in its entirety.

### BACKGROUND

### 1. Technical Field

The present disclosure relates to electrode active material composite particles, an electrode composite material, and a battery.

### 2. Description of Related Art

Japan Unexamined Patent Application Publication No. 2024-073597 (JP 2024-073597 A) discloses a composite containing porous carbon scaffolding and silicon, and an electrode containing such a composite. JP 2024-073597 A discloses a method for embedding silicon into porous carbon scaffolding by chemical vapor deposition (CVD) technology using silane gas.

### SUMMARY

Silicon electrode active materials may expand and contract during charging and discharging of a battery. Accordingly, in a battery containing a silicon electrode active material, volume changes may occur due to such expansion and contraction. Even with electrode active material compound material containing a porous carbon material and silicon, there is room for improvement in terms of suppressing such volume changes in the battery.

An object of the present disclosure is to provide electrode active material composite particles that can suppress volume changes in a battery, an electrode composite material containing such electrode active material composite particles, and a battery containing such an electrode composite material.

The present inventors have found that the above issue can be addressed by the following means.

### First Aspect

Electrode active material composite particles, including
a porous carbon material, and
silicon retained within the porous carbon material, in which
the electrode active material composite particles include pores of 10 nm or smaller, as measured by gas adsorption method, in an amount of 0.22 cc/g or more.

### Second Aspect

The electrode active material composite particles according to the First Aspect, in which the electrode active material composite particles include pores of 2 nm or smaller, as measured by gas adsorption method, in an amount of 0.15 cc/g or more.

### Third Aspect

The electrode active material composite particles according to the First or Second Aspect, in which
the electrode active material composite particles include, as measured by gas adsorption method,
the pores of 10 nm or smaller in an amount of 0.50 cc/g or more and 0.60 cc/g or less, and
the pores of 2 nm or smaller in an amount of 0.25 cc/g or more and 0.35 cc/g or less.

### Fourth Aspect

An electrode composite material including the electrode active material composite particles according to any one of the First to Third Aspects.

### Fifth Aspect

A battery including an electrode active material layer, in which the electrode active material layer contains the electrode composite material according to the Fourth Aspect.

According to the present disclosure, electrode active material composite particles that can suppress volume changes in a battery, an electrode composite material containing such electrode active material composite particles, and a battery containing such electrode composite material, can be provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a graph showing cumulative pore size distribution of an Example, a Comparative Example, and a porous carbon material; and

FIG. 2 is a graph showing differential pore size distribution of the Example, the Comparative Example, and the porous carbon material.

### DETAILED DESCRIPTION OF EMBODIMENTS

An embodiment of the present disclosure will be described below in detail. Note that the present disclosure is not limited to the following embodiment, and can be carried out modified variously, within the scope of the present disclosure.

### Electrode Active Material Composite Particles

Electrode active material composite particles according to the present disclosure include a porous carbon material and silicon retained within the porous carbon material. The electrode active material composite particles according to the present disclosure have pores of 10 nm or smaller, as measured by the gas adsorption method, in an amount of 0.22 cc/g or more.

The present inventors have found that when an electrode active material composite particle containing a porous carbon material and silicon retained within the porous carbon material has a predetermined amount or more of pores with relatively small pore diameters, volume change of the battery that accompanies the expansion and contraction of silicon during charging and discharging of the battery can be suppressed.

The reason for this is presumed to be as follows, without intending to be bound by any theory. That is to say, for example, when manufacturing a battery, particularly a solid-state battery, an electrode active material layer is pressed in some cases. It is believed that pores with a relatively small diameter are less likely to be crushed by the pressing. The electrode active material composite particles according to the present disclosure have a predetermined amount or more of such pores, which is thought to be able to mitigate effects of the above-mentioned expansion and contraction, and thus suppress volume changes in the battery.

The “electrode active material” may be “cathode active material” or “anode active material”, and may particularly be “anode active material”.

Each of the elements making up the electrode active material composite particles according to the present disclosure will be described below.

### Porous Carbon Material

The electrode active material composite particles according to the present disclosure contain a porous carbon material. The porous carbon material retains silicon within pores thereof.

The porous carbon material is not limited in particular. The porous carbon material may be, for example, activated carbon. The porous carbon material may be a material having interconnected pores in which the pores are connected to each other. An example of such a material is a commercially available product, CNovel (registered trademark) MH-00.

The pore diameter and pore volume of the porous carbon material are not limited in particular. The porous carbon material may have pores of 10 nm or smaller, as measured by the gas adsorption method, in an amount of 0.30 cc/g or more, 0.40 cc/g or more, 0.50 cc/g or more, 0.55 cc/g or more, or 0.60 cc/g or more, and also may have pores of 10 nm or smaller in an amount of 1.00 cc/g or less, 0.90 cc/g or less, 0.80 cc/g or less, 0.75 cc/g or less, or 0.70 cc/g or less.

The maximum value of a peak in differential pore size distribution of the porous carbon material measured by the gas adsorption method may be located at 1 nm or more, 2 nm or more, 3 nm or more, or 4 nm or more, and may be located at 10 nm or less, 7 nm or less, 5 nm or less, or 4 nm or less.

The gas adsorption method is not limited in particular, and for example, following measuring the N₂ adsorption isotherm, the cumulative pore size distribution and differential pore size distribution may be obtained by the BJH (Barrett-Joyner-Halenda) method. In this case, a specific surface area and pore size distribution measuring device, BELSORP MAX X, manufactured by Microtrac, can be used. The pore diameter and pore volume can be found from the cumulative pore size distribution and differential pore size distribution thus obtained. The pore diameter and the pore volume of the electrode active material composite particles described below can also be found in a similar manner.

### Silicon

The electrode active material composite particles according to the present disclosure contain silicon retained within a porous carbon material. Silicon functions as an electrode active material, thereby expanding and contracting during charging and discharging of the battery.

The silicon is not limited in particular, and may be, for example, silicon produced using alkoxysilane as a raw material, by the method described below.

The shape, size, and so forth of the silicon are not limited in particular, as long as the silicon functions as an electrode active material. 20

In the electrode active material composite particles according to the present disclosure, the mass ratio of silicon to the porous carbon material may be 0.1 or more and 10.0 or less. This mass ratio may be 0.1 or more, 0.3 or more, 0.5 or more, 0.7 or more, 0.9 or more, or 1.0 or more, and may be 10.0 or less, 7.0 or less, 5.0 or less, 3.0 or less, 2.0 or 25 less, or 1.0 or less. That is to say, the mass ratio of silicon as to the porous carbon material may be 1:1. By setting the mass ratio of silicon to the porous carbon material within the above range, a relation between the pore diameter and the pore volume of the electrode active material composite particles according to the present disclosure can be easily set within the range according to the present disclosure.

### Pores

The electrode active material composite particles according to the present disclosure have pores of 10 nm or smaller, as measured by the gas adsorption method, in an amount of 0.22 cc/g or more. This can mitigate effects of expansion and contraction of silicon during charging and discharging of the battery, thereby suppressing volume change of the battery.

The electrode active material composite particles may have pores of 10 nm or smaller, as measured by the gas adsorption method, in an amount of 0.25 cc/g or more, 0.30 cc/g or more, 0.35 cc/g or more, 0.40 cc/g or more, 0.45 cc/g or more, or 0.50 cc/g or more, and also may have pores of 10 nm or smaller in an amount of 1.00 cc/g or less, 0.90 cc/g or less, 0.80 cc/g or less, 0.75 cc/g or less, 0.70 cc/g or less, 0.65 cc/g or less, 0.60 cc/g or less, or 0.55 cc/g or less. This can effectively suppress the volume change of the battery.

The electrode active material composite particles according to the present disclosure may have pores of 2 nm or smaller, as measured by the gas adsorption method, of 0.15 cc/g or more, 0.20 cc/g or more, or 0.25 cc/g or more, and also may have pores of 2 nm or smaller in an amount of 0.45 cc/g or less, 0.40 cc/g or less, or 0.35 cc/g or less. This can effectively suppress the volume change of the battery.

The electrode active material composite particles according to the present disclosure may have pores of 10 nm or smaller, of 0.40 cc/g or more and 0.70 cc/g or less, 0.45 cc/g or more and 0.65 cc/g or less, or 0.50 cc/g or more and 0.60 cc/g or less, and also may have pores of 2 nm or smaller in an amount of 0.15 cc/g or more and 0.45 cc/g or less, 0.20 cc/g or more and 0.40 cc/g or less, or 0.25 cc/g or more and 0.35 cc/g or less. This can effectively suppress the volume change of the battery.

With respect to the present disclosure, “pores of 10 nm or smaller” and “pores of 2 nm or smaller” include the following:
pores of the porous carbon material that are not filled at all and/or sufficiently with silicon, thereby remaining,
voids formed between silicon and the porous carbon material, in the pores of the porous carbon material filled with silicon, and
pores in porous silicon.

The above-mentioned “voids” and “pores in porous silicon” will be described in detail later, but these may appear by removing magnesium oxide that can be generated in the process of producing the electrode active material composite particles.

### Production Method of Electrode Active Material Composite Particles

The electrode active material composite particles according to the present disclosure can be produced by a method including the following processes:
(a) providing a composite containing silicon oxide within the porous carbon material;
(b) reducing the silicon oxide in the composite using magnesium to obtain an electrode active material composite particle precursor containing silicon and magnesium oxide within the porous carbon material; and
(c) removing at least part of the magnesium oxide from the electrode active material composite particle precursor.

### Providing the Composite

The method may include (a) providing a composite containing silicon oxide within the porous carbon material. For purposes of the present disclosure, “silicon oxide” may be silicon dioxide (SiO₂).

The method for providing the composite containing silicon oxide (SiO₂) in porous carbon material is not limited in particular, and examples thereof include chemical vapor deposition (CVD). Specifically, for example, the following method is exemplified. That is to say, first, the porous carbon material is placed in a furnace tube of a CVD device, and the inside of the furnace tube is depressurized and then heated. Next, an oxygen line is inserted into a vessel containing alkoxysilane, and the alkoxysilane is bubbled with oxygen, thereby introducing oxygen containing alkoxysilane vapor into the furnace tube. A composite containing SiO₂ within the porous carbon material may be provided by maintaining this state.

The alkoxysilane is not limited in particular, and may be, for example, tetraalkoxysilane, or an alkoxysilane modified with a substituent other than an alkoxy group.

The tetraalkoxysilane is not limited in particular, and may be, for example, tetramethoxysilane, tetraethoxysilane, tetrapropoxysilane, tetrabutoxysilane, or a combination thereof, and in particular may be tetraethoxysilane (TEOS).

The alkoxysilane modified with a substituent other than an alkoxy group is not limited in particular. The substituent other than an alkoxy group is not limited in particular, and may be, for example, a methyl group, an ethyl group, a phenyl group, a vinyl group, or the like. The alkoxy group is not limited in particular, and may be, for example, a methoxy group, an ethoxy group, or the like. The number of substituents other than the alkoxy group and the number of alkoxy groups are not limited in particular.

The temperature of heating is not limited in particular, and may be, for example, 100° C. or higher, 300° C. or higher, 400° C. or higher, or 500° C. or higher, and also may be 1000° C. or lower, 800° C. or lower, 600° C. or lower, or 500° C. or lower.

The time over which the state, in which oxygen containing alkoxysilane vapor is introduced into the furnace tube, is maintained is not limited in particular, and may be, for example, 1 hour or more, 3 hours or more, 5 hours or more, or 6 hours or more, or may be 30 hours or less, 20 hours or less, 15 hours or less, 10 hours or less, 8 hours or less, or 6 hours or less.

### Reduction of Silicon Oxide

The above method may include (b) reducing the silicon oxide (SiO₂) in the composite using magnesium (Mg) to obtain an electrode active material composite particle precursor containing silicon (Si) and magnesium oxide (MgO) within the porous carbon material.

The method for reducing SiO₂ using Mg is not limited in particular, and examples thereof include a method in which Mg vapor is brought into contact with the composite. The method for generating the Mg vapor is not limited in particular, and examples thereof include a method of heating a reducing agent that serves as an Mg source, such as an Mg alloy, metallic Mg, or the like.

The Mg alloy is not limited in particular, and may be, for example, at least one type selected from Mg₂Si, MgCa, MgCu₂, MgNi₂, and MgSn.

The pressure when reducing SiO₂ using Mg is not limited in particular. This pressure may be, for example, less than 1 atmosphere, 100 Pa or less, or 20 Pa or less. This pressure may be, for example, an Mg vapor pressure that is equal to or below equilibrium pressure of the reversible decomposition reaction of Mg₂Si decomposing into Mg vapor and Si.

The temperature when reducing SiO₂ using Mg is not limited in particular, and may be, for example, 500° C. or higher, 600° C. or higher, or 650° C. or higher, and may be 900° C. or lower, 800° C. or lower, 700° C. or lower, or 650° C. or lower. Thus, the volume of pores with a diameter of 20 nm or less in the porous silicon, obtained after process (c) described below, can be increased.

The time for reducing SiO₂ using Mg is not limited in particular, and may be, for example, 1 hour or more, 3 hours or more, 5 hours or more, or 10 hours or more, and also may be 30 hours or less, 20 hours or less, 15 hours or less, or 10 hours or less.

The amount of the Mg source may be an amount that generates 1 molar equivalent or more of Mg vapor relative to the number of moles of SiO₂, i.e., an amount that can appropriately reduce the SiO₂.

The mass ratio of the Mg source to the composite is not limited in particular as long as the SiO₂ can be appropriately reduced. This mass ratio may be, for example, 1 or more, 2 or more, or 2.5 or more, and may be 10 or less, 5 or less, or 2.5 or less.

Specific examples of the method for process (b) include the following methods. That is to say, first, the composite and the Mg source are placed in a reaction vessel. Next, the reaction vessel is placed in a vacuum furnace, and the temperature is raised while the inside of the vacuum furnace is evacuated by a rotary pump, and the reaction vessel is heated.

### Removal of Magnesium Oxide

The above method may include (c) removing at least part of the MgO from the electrode active material composite particle precursor. As a result, electrode active material composite particles are produced. Also, removing MgO forms voids between the Si and the porous carbon material in the pores of the Si-filled porous carbon material, and also the silicon in the electrode active material composite particles is made porous, thereby producing porous silicon.

The method for removing at least part of the MgO is not limited in particular, and examples include a method in which the electrode active material composite particle precursor is treated with an acid.

The method for treating the electrode active material composite particle precursor with an acid is not limited in particular, and an example thereof is a method in which the electrode active material composite particle precursor is mixed with the acid.

The acid is not limited in particular, and examples thereof include inorganic acids such as hydrochloric acid, nitric acid, sulfuric acid, and so forth.

The concentration of the acid is not limited in particular, and can be set as appropriate in accordance with the type of acid.

When the MgO is removed using an acid, the above method may further include washing the electrode active material composite particles with water, alcohol, or the like, drying, and so forth.

### Electrode Composite Material

An electrode composite material according to the present disclosure contains the electrode active material composite particles according to the present disclosure. The electrode composite material may optionally contain a solid electrolyte, a conductive aid, a binder, and so forth.

In the present disclosure, the term “electrode composite material” refers to a composition by which an electrode active material layer can be made, either by itself or in further combination with other components. Also, with respect to the present disclosure, the term “electrode composite material slurry” refers to a slurry that contains a dispersion medium in addition to the “electrode composite material” and that can be applied and dried to form an electrode active material layer.

In the context of the present disclosure, the “electrode composite material” may be either a “cathode composite material” or an “anode composite material”, and may particularly be an “anode composite material”.

Hereinafter, each of the elements making up the electrode composite material according to the present disclosure will be described.

### Electrode Active Material Composite Particles

The above description can be referenced with regard to the electrode active material composite particles.

The content of the electrode active material composite particles in the electrode composite material is not limited in particular, and can be set as appropriate in consideration of a desired capacity of the battery, or the like.

### Solid Electrolyte

Examples of the solid electrolyte include inorganic solid electrolytes such as a sulfide solid electrolyte, an oxide solid electrolyte, a nitride solid electrolyte, a halide solid electrolyte, or the like, and organic polymer electrolytes such as a polymer electrolyte or the like. The solid electrolyte may particularly be a sulfide solid electrolyte.

When the battery is a lithium-ion secondary battery, for example, the solid electrolyte may have lithium ion conductivity.

Examples of sulfide solid electrolytes having lithium ion conductivity include solid electrolytes containing an Li element, an X element (X is at least one type of P, As, Sb, Si, Ge, Sn, B, Al, Ga, and In), and an S element. Also, the sulfide solid electrolyte may further contain at least one of an O element and a halogen element. Examples of halogen elements include an F element, a Cl element, a Br element, and an I element.

Examples of sulfide solid electrolytes include Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are positive numerals, and Z is any one of Ge, Zn, and Ga), Li₂S—GeS₂, Li₂S—SiS₂—Li₃PO₄, Li₂S—SiS₂—LiₓMO_{y} (where x and y are positive numerals, and M is any one of P, Si, Ge, B, Al, Ga, and In).

Examples of oxide solid electrolytes having lithium ion conductivity include solid electrolytes containing an Li element, a Y element (Y is at least one of Nb, B, Al, Si, P, Ti, Zr, Mo, W, and S), and an O element. Specific examples of the oxide solid electrolyte include garnet solid electrolytes such as Li₇La₃Zr₂O₁₂, Li₇₋ₓLa₃(Zr₂₋ₓNbₓ)O₁₂ (0≤x≤2), Li₅La₃Nb₂O₁₂, and so forth; perovskite solid electrolytes such as (Li, La) TiO₃, (Li, La)NbO₃, (Li, Sr)(Ta, Zr)O₃, and so forth; NASICON solid electrolytes Li (Al, Ti)(PO₄)₃ and Li (Al, Ga)(PO₄)₃; Li—P—O-based solid electrolytes such as Li₃PO₄, LIPON (compound in which part of O of Li₃PO₄ is substituted with N), and so forth; and Li—B—O-based solid electrolytes such as Li₃BO₃, a compound in which part of O of Li₃BO₃ is substituted with C, and so forth.

The content of the solid electrolyte in the electrode composite material is not limited in particular, and can be set as appropriate in consideration of desired ion conductivity, and so forth.

### Conductive Aid

The conductive aid may be, for example, a carbon material, metal particles, or a combination thereof. The carbon material may be, for example, a non-fibrous carbon material such as acetylene black (AB), Ketjen black (KB), or the like; a fibrous carbon material such as vapor grown carbon fiber (VGCF), carbon nanotubes (CNT), and carbon nanofibers (CNF), or a combination thereof. The metal particles may be, for example, nickel, copper, iron, stainless steel, or the like, or a combination thereof.

The content of the conductive aid in the electrode composite material is not limited in particular and can be set as appropriate taking into consideration the desired conductivity and the like.

### Binder

The binder may be, for example, a rubber-based binder such as butadiene rubber, hydrogenated butadiene rubber, styrene butadiene rubber (SBR), hydrogenated styrene butadiene rubber, nitrile butadiene rubber, hydrogenated nitrile butadiene rubber, acrylate butadiene rubber (ABR), ethylene propylene rubber, or the like; a fluoride-based binder such as polyvinylidene difluoride (PVDF), polyvinylidene difluoride-polyhexafluoropropylene copolymer (PVDF-HFP), polytetrafluoroethylene, fluororubber, or the like; a polyolefin-based thermoplastic resin such as polyethylene, polypropylene, polystyrene, or the like; an imide-based resin such as polyimide, polyamideimide, or the like; an amide-based resin such as polyamide or the like; an acrylic resin such as polymethyl acrylate, polyethyl acrylate, or the like; a methacrylic-based resin such as polymethyl methacrylate, polyethyl methacrylate, or the like; or a combination thereof.

The content of the binder in the electrode composite material is not limited in particular, and can be set as appropriate in consideration of desired binding properties and the like.

### Other Components

The electrode composite material may contain or may not contain further components other than those described above.

### Battery

The battery according to the present disclosure has an electrode active material layer, and also the electrode active material layer contains the electrode composite material according to the present disclosure. The battery according to the present disclosure may include an anode current collector layer, an anode active material layer, an electrolyte layer, a cathode active material layer, and a cathode current collector layer, in this order. In this case, the electrode active material layer containing the electrode composite material according to the present disclosure may be the anode active material layer or the cathode active material layer, and in particular may be the anode active material layer.

The battery according to the present disclosure may be a liquid battery or a solid-state battery, and in particular may be a solid-state battery. It should be noted that, in the context of the present disclosure, a “solid-state battery” refers to a battery that contains at least a solid electrolyte as an electrolyte, and therefore a solid-state battery may be a combination of a solid electrolyte and a liquid electrolyte as the electrolyte. Also, a solid-state battery may also be an all-solid-state battery, i.e., a battery containing only a solid electrolyte as the electrolyte.

The battery according to the present disclosure may be a primary battery or a secondary battery, and in particular may be a lithium-ion secondary battery.

The battery according to the present disclosure may be restrained by restraining members such as end plates or the like, from both sides in a laminating direction of the above-described layers. An example of a restraining method is a method that utilizes restraining torque of bolts or the like, but is not limited thereto.

Each of the elements making up the battery according to the present disclosure will be described below. Note that description will be given below regarding an example in which the electrode active material layer containing the electrode composite material according to the present disclosure is an anode active material layer.

### Anode Current Collector Layer

The anode current collector layer may be in the form of a foil, plate, mesh, punched metal, foam, and so forth. The anode current collector layer may be a metal foil or a metal mesh, or may be a carbon sheet, and may particularly be a metal foil. The anode current collector layer may be made of a plurality of foils, sheets, or the like.

Metal making up the anode current collector layer is not limited in particular, and may be, for example, copper, nickel, chromium, gold, platinum, silver, aluminum, iron, titanium, zinc, cobalt, stainless steel, or the like. In particular, the anode current collector layer may contain at least one type of metal selected from among copper, nickel, and stainless steel.

For the purpose of adjusting resistance or the like, some sort of coating layer may be formed on the surface of the anode current collector layer. Also, the anode current collector layer may be formed by plating or vapor deposition of any of the above metals onto a metal foil or a substrate. Also, when made of a plurality of metal foils, the anode current collector layer may further include some sort of layer interposed between these metal foils.

The thickness of the anode current collector layer is not limited in particular, and may be, for example, 0.1 μm or more, or 1 μm or more, and may be 1 mm or less, or 100 μm or less.

### Anode Active Material Layer

The anode active material layer contains the electrode composite material according to the present disclosure. The above description can be referenced regarding the electrode composite material according to the present disclosure. The anode active material layer may be formed by forming the electrode composite material according to the present disclosure, itself, into a layer.

The thickness of the anode active material layer is not limited in particular, and may be, for example, 0.1 μm or more and 1000 μm or less.

### Solid Electrolyte Layer

The solid electrolyte layer contains at least solid electrolyte particles, and may optionally further contain a binder and so forth.

The above description can be referenced regarding the solid electrolyte particles and the binder.

The thickness of the solid electrolyte layer is not limited in particular, and may be, for example, 0.1 μm or more and 1000 μm or less.

### Cathode Active Material Layer

The cathode active material layer contains at least a cathode active material, and may optionally further contain a solid electrolyte, a conductive aid, a binder, and so forth.

The cathode active material is not limited in particular, and may be, for example, an oxide active material. The oxide active material used in a lithium-ion battery may be, for example, LiCoO₂, LiMnO₂, Li₂NiMn₃O₈, LiVO₂, LiCrO₂, LiFePO₄, LiCoPO₄, LiNiO₂, LiNi_{1/3}Co_{1/3}Mn_{1/3}O₂, or the like. Also, a coating layer containing a Li-ion conductive oxide, such as for example, LiNbO₃ or the like, may be formed on the surface of these active materials.

The content of the cathode active material in the cathode active material layer is not limited in particular.

The above description can be referenced regarding the solid electrolyte, the conductive aid, and the binder.

The thickness of the cathode active material layer is not limited in particular, and may be, for example, 0.1 μm or more and 1000 μm or less.

### Cathode Current Collector Layer

The cathode current collector layer may be in the form of a foil, plate, mesh, punched metal, foam, and so forth. The cathode current collector layer may be a metal foil or a metal mesh, and in particular may be a metal foil. The cathode current collector layer may be made of a plurality of foils.

The metal making up the cathode current collector layer may be copper, nickel, chromium, gold, platinum, silver, aluminum, iron, titanium, zinc, cobalt, stainless steel, or the like, and the cathode current collector layer may, in particular, contain aluminum.

For the purpose of adjusting the resistance or the like, some sort of coating layer may be formed on the surface of the cathode current collector layer. Also, the cathode current collector layer may also be formed by plating or vapor deposition of any of the above metals onto a metal foil or a substrate. Also, when made of multiple metal foils, the cathode current collector layer may include some sort of layer interposed between these metal foils.

The thickness of the cathode current collector layer is not limited in particular, and may be, for example, 0.1 μm or more, or 1 μm or more, and may be 1 mm or less, or 100 μm or less.

### Other Configurations

The battery may be a battery in which the above configurations are accommodated inside an outer encasement. Any known outer encasement for a battery can be employed as the outer encasement. Also, a plurality of batteries may be electrically connected in any manner and stacked in any manner to form a battery pack. In this case, this battery pack may be accommodated inside a known battery case. The battery may also include other obvious components, such as necessary terminals and so forth. The shape of the battery may be, for example, a coin shape, a laminate (pouch) shape, a cylindrical shape, a rectangular shape, or the like.

The method for manufacturing the battery of the present disclosure is not limited in particular, and includes, for example, forming an electrode active material layer containing the electrode composite material according to the present disclosure.

An example of the method for forming the electrode active material layer containing the electrode composite material is a method in which constituent materials such as the electrode active material composite particles or the like are mixed to obtain an electrode composite material, and the electrode composite material, which is obtained, is then formed by dry forming or wet forming.

The method for manufacturing the battery of the present disclosure may further include laminating an anode current collector layer, an anode active material layer, a solid electrolyte layer, a cathode active material layer, and a cathode current collector layer, in this order, to form an electrode laminate.

Other members, such as terminals or the like, may be attached to the electrode laminate as necessary. The electrode laminate is accommodated in a battery case and sealed, thereby obtaining a battery.

### EXAMPLE

Synthesis of electrode active material composite particles

### Providing the Composite

First, 1 g of porous carbon material was placed in a furnace tube of a CVD device, and pressure inside of the furnace tube was reduced, and then heated to 500° C. Next, an oxygen line was inserted into a container containing tetraethoxysilane (TEOS), and oxygen was bubbled through the TEOS, thereby introducing oxygen containing TEOS vapor into the furnace tube. This state was maintained for 6 hours to prepare a composite containing silicon dioxide (SiO₂) within the porous carbon material. The furnace tube was cooled, and the inside of the furnace tube was replaced with argon gas, after which the composite, which was obtained, was recovered.

### Reduction of Silicon Oxide

The composite and the Mg alloy were placed in a reaction vessel. Next, the reaction vessel was placed in a vacuum furnace, the temperature was raised to 650° C. over a period of 1 hour while evacuating the inside of the vacuum furnace with a rotary pump, and the reaction vessel was heated at this temperature for 10 hours. Thus, SiO₂ was reduced to prepare an electrode active material composite particle precursor containing silicon (Si) and magnesium oxide (MgO) in the porous carbon material. After the vacuum furnace cooled, the electrode active material composite particle precursor, which was obtained, was recovered.

### Removal of Magnesium Oxide

Next, 1 g of the electrode active material composite particle precursor and 100 mL of hydrochloric acid, 6% by weight, were placed in a beaker, and then stirred for 1 hour. The mixture was filtered under reduced pressure and then dried in vacuo. Thus, electrode active material composite particles were obtained. In the electrode active material composite particles, which were obtained, voids were formed between the Si and the porous carbon material in the pores of the Si-filled porous carbon material, and also the silicon in the electrode active material composite particles was made to be porous, resulting in the production of porous silicon.

### Formation of Anode Active Material Layer

Butyl butyrate, a 5% by weight butyl butyrate solution of a polyvinylidene fluoride (PVDF)-based binder, vapor-grown carbon fiber (VGCF) as a conductive aid, the electrode active material composite particles, which were obtained, and a Li₂S—P₂S₅-based glass ceramic as a sulfide solid electrolyte, were placed in a polypropylene container, and stirred for 30 seconds using an ultrasonic disperser (UH-50, manufactured by SMT Co., Ltd.). Next, the container was shaken for 30 minutes in a shaker (TTM-1, manufactured by Sibata Scientific Technology Ltd.) to obtain an anode composite material slurry. The anode composite material slurry, which was obtained, was applied onto a copper (Cu) foil serving as an anode current collector layer, by the doctor blade method, using an applicator, and then dried on a hot plate heated to 100° C. for 30 minutes, thereby forming an anode active material layer on the anode current collector layer.

### Formation of Solid Electrolyte Layer

Heptane, a 5% by weight heptane solution of a butadiene rubber (BR)-based binder, and Li₂S—P₂S₅-based glass ceramic as a sulfide solid electrolyte, were placed in a polypropylene container, and stirred for 30 seconds using an ultrasonic disperser (UH-50, manufactured by SMT Co., Ltd.). Next, the container was shaken for 30 minutes in a shaker (TTM-1, manufactured by Sibata Scientific Technology Ltd.) to obtain a solid electrolyte slurry. The solid electrolyte slurry, which was obtained, was applied onto an aluminum (Al) foil serving as a release sheet, by the doctor blade method, using an applicator. The Al foil coated with the solid electrolyte slurry was dried on a hot plate heated to 100° C. for 30 minutes to form a solid electrolyte layer. Three solid electrolyte layers were fabricated.

### Formation of Cathode Active Material Layer

Butyl butyrate, a 5% by weight butyl butyrate solution of a polyvinylidene fluoride (PVDF)-based binder, LiNi_{1/3}Co_{1/3}Mn_{1/3}O₂ with an average particle size of 6 μm as a cathode active material, Li₂S—P₂S₅-based glass ceramic as a sulfide solid electrolyte, and VGCF as a conductive aid, were placed in a polypropylene container, and the mixture was stirred for 30 seconds using an ultrasonic disperser (UH-50, manufactured by SMT Co., Ltd.). Next, the container was shaken for 3 minutes in a shaker (TTM-1, manufactured by Shibata Scientific Co., Ltd.), stirred for 30 seconds with the ultrasonic disperser, and further shaken for 3 minutes in the shaker, to obtain a cathode composite material slurry. The cathode composite material slurry, which was obtained, was applied onto an Al foil (manufactured by Showa Denko K.K.) as a cathode current collector layer, by the doctor blade method, using an applicator. The Al foil coated with the cathode composite material slurry was dried on a hot plate heated to 100° C. for 30 minutes to form a cathode active material layer on the cathode current collector layer.

### Fabrication of Battery

The anode current collector layer, the anode active material layer, and a first solid electrolyte layer were laminated in this order. Note that lamination of the solid electrolyte layer was performed such that a face thereof on which the Al foil was not placed faced the anode active material layer. This laminate was set in a roll press and pressed at a pressing pressure of 60 kN/cm at a pressing temperature of 25° C. to obtain a densified anode laminate.

The cathode current collector layer, the cathode active material layer, and a second solid electrolyte layer were laminated in this order. Note that lamination of the solid electrolyte layer was performed such that a face thereof on which the Al foil was not placed faced the cathode active material layer. This laminate was set in a roll press and pressed at a pressing pressure of 100 kN/cm at a pressing temperature of 165° C. to obtain a cathode laminate.

The area of the anode laminate was greater than the area of the cathode laminate.

The Al foil serving as a release sheet was peeled off from the surface of the first solid electrolyte layer. A third solid electrolyte layer was laminated on the first solid electrolyte layer of the anode laminate that was thus exposed. This laminate was set in a flat uniaxial pressing machine and temporarily pressed under 100 MPa at 25° C. for 10 seconds. The Al foil was peeled off from the third solid electrolyte layer to obtain an anode laminate on which the third solid electrolyte layer was further laminated.

The Al foil serving as a release sheet was peeled off from the surface of the second solid electrolyte layer. The second solid electrolyte layer was laminated on the third solid electrolyte layer. This laminate was set in a planar uniaxial press and pressed at a pressing pressure of 200 MPa at a pressing temperature of 120° C. for 1 minute. Thus, an all-solid-state battery according to Example 1 was obtained.

### COMPARATIVE EXAMPLE

Electrode active material composite particles according to a comparative example and an all-solid-state battery including the same were obtained in the same manner as in the Example, except that in the composite providing step, monosilane gas was introduced into the furnace tube instead of oxygen containing TEOS vapor.

### Obtaining Pore Size Distribution

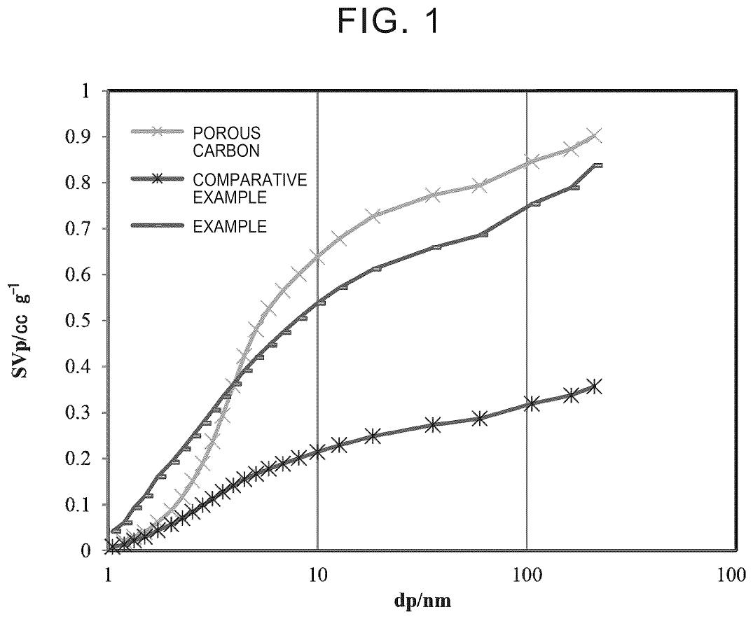

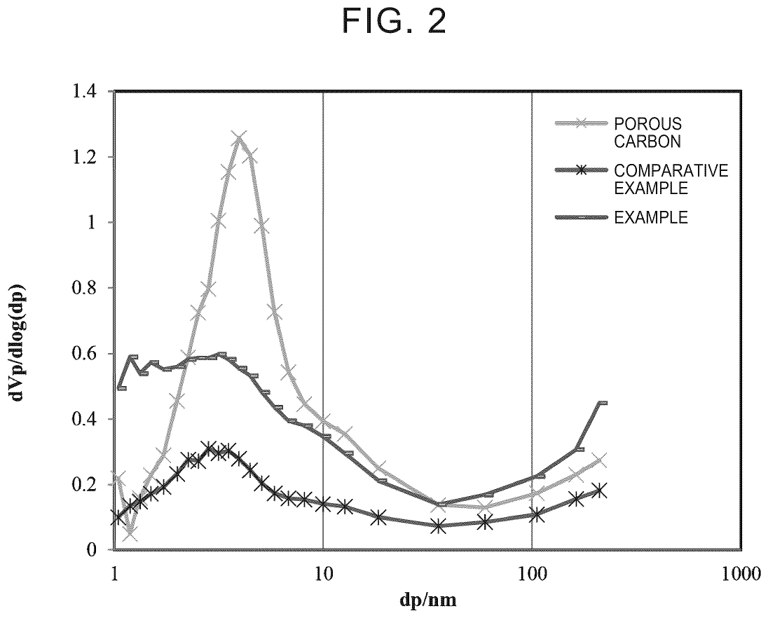

For the electrode active material composite particles according to the Examples, and the porous carbon material, the N₂ adsorption isotherm was measured, and then the cumulative pore size distribution and the differential pore size distribution were obtained by the BJH (Barrett-Joyner-Halenda) method. In the measurement by the BJH method, a specific surface area and pore size distribution measuring device, BELSORP MAX X, manufactured by Microtrac, was used. The cumulative pore size distribution and the differential pore size distribution, which were obtained, are shown in FIGS. 1 and 2, respectively. From the pore size distribution thus obtained, the pore volume of pores of a predetermined size was found.

### Evaluation of Amount of Increase in Restraining Pressure

Using a restraining jig, the batteries of the Examples that were fabricated were restrained at a predetermined restraining pressure, and the amount of increase in restraining pressure was measured when the batteries were charged at a constant current and a constant voltage up to 4.55 V at a 10-hour rate ( 1/10 C). The amount of increase in restraining pressure is a difference between the maximum value and the minimum value of the restraining pressure, and is an index of the amount of increase in the volume of the battery.

The results are shown in Table 1. In Table 1, the values of the amount of increase in restraining pressure of the Example are shown as relative values with values of the Comparative Example as 1.00.

TABLE 1

| | Pore volume of 10 nm | Amount of increase in |
|---|---|---|
| | or smaller | restraining pressure |
| | [cc/g] | [—] |
| Example | 0.54 | 0.86 |
| Comparative Example | 0.21 | 1.00 |

As shown in Table 1, in the batteries of the Example containing electrode active material composite particles having pores of 10 nm or smaller in an amount of 0.22 cc/g or more, the amount of increase in restraining pressure was small.

As shown in FIG. 1, the electrode active material composite particles contained in the battery of the Example had pores of 2 nm or less in an amount of 0.25 cc/g or more and 0.35 cc/g or less.

As shown in FIGS. 1 and 2, the pore size distribution of the electrode active material composite particles contained in the battery of the Example was different from the pore size distribution of the porous carbon material that was the raw material. This suggests that the electrode active material composite particles contained in the battery of the Example contain, in addition to the pores of the porous carbon material that are not filled at all and/or not sufficiently filled with silicon and therefore remain, voids formed between the silicon and the porous carbon material in the pores of the porous carbon material filled with silicon, and pores of the porous silicon (porous silicon).

What is claimed is:

1. Electrode active material composite particles, comprising:
a porous carbon material; and
silicon retained within the porous carbon material, wherein
the electrode active material composite particles include pores of 10 nm or smaller, as measured by gas adsorption method, in an amount of 0.22 cc/g or more.

2. The electrode active material composite particles according to claim 1, wherein the electrode active material composite particles include pores of 2 nm or smaller, as measured by gas adsorption method, in an amount of 0.15 cc/g or more.

3. The electrode active material composite particles according to claim 1, wherein
the electrode active material composite particles include, as measured by gas adsorption method,
the pores of 10 nm or smaller in an amount of 0.50 cc/g or more and 0.60 cc/g or less, and
the pores of 2 nm or smaller in an amount of 0.25 cc/g or more and 0.35 cc/g or less.

4. An electrode composite material comprising the electrode active material composite particles according to claim 1.

5. A battery comprising an electrode active material layer, wherein the electrode active material layer contains the electrode composite material according to claim 4.
